(19) United States
(12) Patent Application Publication
(10) Pub. No.: US 2010/0066072 A1
(43) Pub. Date: Mar. 18, 2010

(54) Security Or Valuable Document With At Least Two Display Devices

(75) Inventors: Manfred Paeschke, Wandlitz (DE); Malte Pflughoefft, Berlin (DE); Guenter Beyer-Meklenburg, Neuruppin (DE); Joachim Kueter, Berlin (DE)

Correspondence Address: GIBSON & DERNIER LLP, 900 ROUTE 9 NORTH, SUITE 504, WOODBRIDGE, NJ, 07095, US

(73) Assignee: BUNDESDRUCKEREI GMBH, Berlin (DE)

(21) Appl. No.: 12/305,229

(22) PCT Filed: Jun. 26, 2007
(86) PCT No.: PCT/EP2007/056416

§ 371 Date: Feb. 23, 2009

(30) Foreign Application Priority Data
Jun. 29, 2006 (DE) 10 2006 030 406.3

(51) Int. Cl. B42D 15/00

(52) U.S. Cl. 283/83

(57) ABSTRACT

The invention relates to a security or valuable document having at least first and second display devices (118; 128), a processor (102, 108) for driving the at least first and second display devices, an interface (112) for supplying power to the processor from an external power source (114, 136).

The invention relates to a security or valuable document and to a writing device for carrying out write access to a data memory of the document.

Documents having an integrated electronic circuit are known per se in different forms from the prior art. For example, there are documents of this type in a predominantly paper-based form, for example in the form of an electronic passport, or in the form of a chip card, in particular a so-called smart card, in a design with or without contacts, or a dual-interface design.

In particular, various radio detection systems, which are also referred to as Radio Frequency Identification (RFID) systems, are known for such documents from the prior art. Previously known RFID systems generally comprise at least one transponder and a transceiving unit. The transponder is also referred to as an RFID sticker, RFID chip, RFID tag, RFID label or radio label; the transceiving unit is also referred to as a reading device or reader. Furthermore, integration with servers, services and other systems, for example cash register systems or merchandise management systems, by means of so-called middleware is often provided.

The data stored on an RFID transponder are made available using radio waves. At low frequencies, this is effected inductively using a near field and, at higher frequencies, using an electromagnetic far field. The distance over which an RFID transponder can be addressed and read fluctuates between a few centimeters and more than one kilometer on the basis of the design (passive/active), the frequency band used, the transmission strength and other environmental influences.

An RFID transponder usually comprises a microchip and an antenna which are accommodated in a carrier or housing or are printed onto a substrate. Active RFID transponders also have a power source, for example a battery.

RFID transponders can be used for different documents, in particular in chip cards, for example in order to implement an electronic purse or for electronic ticketing. Furthermore, they are integrated in paper or plastic, for example in security and valuable documents, in particular banknotes and identification documents.

DE 201 00 158 U1 discloses, for example, an identification and security card which is made of laminated and/or injected plastics and comprises an integrated semiconductor having an antenna for carrying out an RFID method. DE 10 2004 008 841 A1 has also disclosed a book-like security document, for example a passport book, which comprises a transponder unit.

Such valuable or security documents are partly implemented in the form of chip cards in the prior art. Chip cards may have an integrated display device, as is disclosed, for example, in EP 0920675, WO2004/080100 and U.S. Pat. No. 6,019,284.

U.S. Pat. No. 6,340,965 B1 also discloses electronic paper which is used to form a reusable form.

U.S. Pat. No. 6,019,284 and EP 0 920 675, for example, disclose flexible cards having a display. However, these cards have only a single one-sided display element.

The company AU Optronics has also presented a double-sided OLED display which can display two color images independently of one another on its front and rear sides. Such displays are intended for use in cell phones.

Valuable or security documents may be provided with an interface with or without contacts, for example an RFID interface, or may be provided with an interface which allows both wire-bound and wireless communication with a chip card terminal. The latter are also referred to as so-called dual-interface chip cards. Chip card communication protocols and methods are defined, for example, in the ISO 14443 standard.

A disadvantage of such documents with RFID functionality is that the RFID interface can be addressed, without the consent of the bearer of the document, if the document is situated, for example, in the bearer's wallet. Protective mechanisms for protecting against unauthorized reading of the data from such a document are also referred to as “Basic Access Control”, cf., in this respect, “Machine Readable Travel Document”, Technical Report, PKI for Machine Readable Travel Documents Offering ICC Read-Only Access, Version 1.1, Oct. 1, 2004, International Civil Aviation Organization (ICAO) (http://www.icao.int/mrtd/download/documents/TR-PKI%20mrtds% 20ICC%20read-only%20access%20v1_{—}1.pdf)

The prior art also discloses methods of electronically storing data with cryptographic protection. Electronic chip cards, which are standardized by ISO 7816, parts 1 to 4, are one form of protected memories which has become very widespread in the past two decades. The fields of use of chip card technology include the introduction of machine-readable travel documents, which is hoped to increase the security and efficiency of passenger checks, in particular in global aviation.

Only a few methods are available nowadays for updating personal information on security or valuable documents. On the one hand, it may be necessary to reissue the document, which ensures the security of the document and protection against alteration and falsification. However, this is a complicated and, in the case of modern personal documents, expensive approach. For this reason, for example in the case of a move in Germany, the new address is applied to the document using a sticker. Although the security and inalterability of the document are still ensured, the updated data, that is to say the indication of the new address, are not protected against alteration or removal to the same extent as the original data.

In contrast, the invention is based on the object of providing a security and valuable document which both makes it possible for personal data to be altered by an authorized entity, for example an authority, and also ensures that such data are protected against being altered or falsified by unauthorized persons. Furthermore, the invention is based on a writing device for carrying out external write access to the data memory of the document.

The objects on which the invention is based are respectively achieved by the features of the independent patent claims. Preferred embodiments of the invention are specified in the dependent patent claims.

Embodiments of a security or valuable document according to the invention afford improved protection against manipulation and/or forgery since such a security or valuable document having two display devices cannot be manipulated or copied or can be manipulated or copied only with difficulty. On the other hand, embodiments of the security or valuable document according to the invention make it possible for the authorized entity to update personalization data, in particular personal information, essentially the same protection as regards alteration or removal as in the case of the original data being provided for the updated data.

According to the invention, it is also particularly advantageous that the security or valuable document does not have to have its own power supply source, for example a battery, but that the power is supplied via an interface of the security or valuable document. This is particularly advantageous for ensuring the functionality of the security or valuable document over its entire lifetime. In this case, it is particularly advantageous if the interface is in the form of a contactless interface since the problem of corrosion of the contacts of the interface over the lifetime of the security or valuable document is then also eliminated.

According to one embodiment of the invention, at least one of the display devices of the security or valuable document is designed in such a manner that it does not have to consume power in order to display information. Such a display device may be implemented, for example, using bistable display technology. This has the advantage that, in any case, the information displayed on this display device of the security or valuable document can be read even when there is no reading device available.

According to one embodiment of the invention, the display devices are based on the same technology, particularly preferably on bistable display technology, for example electrophoretic, electrochromic or rotating element display technology.

The fact that the at least first and second display devices are driven by the same processor results in the need to contact-connect the two display devices inside the security or valuable document to this one processor. This provides a particular degree of security against forgery and manipulation.

According to one embodiment of the invention, the security or valuable document has a thickness of at most 2 mm, preferably at most 1 mm, in particular at most 840 μm. Such a flat embodiment of the security or valuable document has the advantage of particular anti-forgery security and security against manipulation as well as the handling advantage of particular flexibility.

According to one embodiment of the invention, the security or valuable document has at least one respective display device on both sides, different information respectively being able to be displayed statically, quasi-statically or variably on the display devices. In particular, the present invention thus makes it possible to produce an internationally interoperable security and valuable document which conforms to the stipulations of the ICAO and can output static, quasi-static and/or variable information on both sides using the corresponding display devices.

One embodiment of the invention provides a document having a data memory for storing personalization data. The document has at least one first display device for displaying the personalization data, means for carrying out a cryptographic protocol and an interface for external write access to the data memory in order to alter the personalization data, the external write access presupposing that the cryptographic protocol has been carried out.

The invention makes it possible for the alterable personal data displayed on a security and valuable document to be altered in a secure manner. For this purpose, the alterable personal data are transmitted to the data memory of the document using a cryptographic protocol and, from there, are displayed on the display element. This dispenses with the need to issue a new document or update personalization data with reduced security against manipulation.

In comparison with the prior art, this has the advantage that the document does not need to be replaced with a new one if personalization data have changed. Furthermore, according to the invention, the document also does not need to be modified, for example by an authorized authority applying an additional imprint or sticker, but rather the personalization data can be updated solely electronically by means of external write access.

For the purpose of interoperability of embodiments of the security or valuable document according to the invention, the secure interchange of data between a terminal, for example a writing and/or reading device, and the document is preferably effected in such a manner that the international security standards prescribed by the ICAO are complied with, in particular as regards Basic Access Control (BAC) and Extended Access Control (EAC).

According to one embodiment of the invention, the document has a display device on which the personalization data and/or the identifier can be output. In principle, any desired display technologies can be used in this case, for example a liquid crystal display (LCD), an organic light-emitting diode (OLED), a rotating element display, electrochromic, electrophoretic and/or electrowetting display technologies. In embodiments of the invention, the displays are at least partially applied using printing technology; OLED displays as well as electrochromic and electrophoretic displays are particularly suitable for this.

According to one embodiment of the invention, at least the personalization data are displayed on a bistable display device which does not have to constantly consume electrical power in order to display the personalization data. This has the advantage that the personalization data can be read even without an electrical power supply on the document. This has the additional advantage that it is possible to dispense with a power supply which is integrated in the document, for example a battery or a solar cell.

If, according to the invention, an identifier, a single-use password, a random number or the like is displayed on a display element, either the display technology used and/or a suitable protocol is/are preferably used to ensure that this content is no longer displayed on the display element after the transaction. If a bistable display element is used, a defined state (“empty state”) or any desired non-relevant information can be displayed, for example after the transaction has been concluded, in order to erase the previously displayed information.

According to one embodiment of the invention, the document has a memory area for storing inalterable personalization data. Examples of inalterable personalization data may be name, date of birth, period of validity, document number, passport photo and further biometric data. The inalterable personalization data may be printed on the document and/or output using one of the display devices, preferably a bistable display device. The inalterable personalization data cannot be changed in the data memory even after a cryptographic protocol has been successfully carried out.

These data may be input to the document by an authorized authority only when the document is first issued. If these data are displayed using a display, this results in the advantage that documents can be prefabricated in a centralized manner and can be personalized in a decentralized manner since a security printing system is not required for personalization.

According to one embodiment of the invention, the first and second display devices are visible from opposite sides of the document. The first and/or second display device can essentially fill the entire area of the front side or rear side of the document. The latter is particularly advantageous if the intention is to completely dispense with printing personal data on the document. However, the display devices may also occupy only part of the front or rear side of the document. In addition, static security printing elements, for example so-called guilloches, may be applied to the document using printing technology.

According to one embodiment of the invention, the document has an inlay on or in which conductor tracks for contact-connecting the display devices are formed. In particular, plated-through holes, so-called vias, may be formed on or in the inlay in order to contact-connect the display devices which are visible from different sides of the document.

According to another embodiment, a flexible display which displays different information on both sides itself constitutes the document body or a part thereof.

According to one embodiment of the invention, the processor, the data memory, the means for carrying out a cryptographic protocol and/or the interface are integrated to form an electronic circuit, for example a microcontroller. This electronic circuit may be arranged on or in the inlay.

According to one embodiment of the invention, the document is an identification document, a passport, an ID card, a visa, a driving license, a company ID card, an authorization permit or the like.

In particular, the document may be paper-based and/or plastic-based and/or in the form of a chip card.

Preferred embodiments of the invention are explained in more detail below with reference to the drawings, in which:

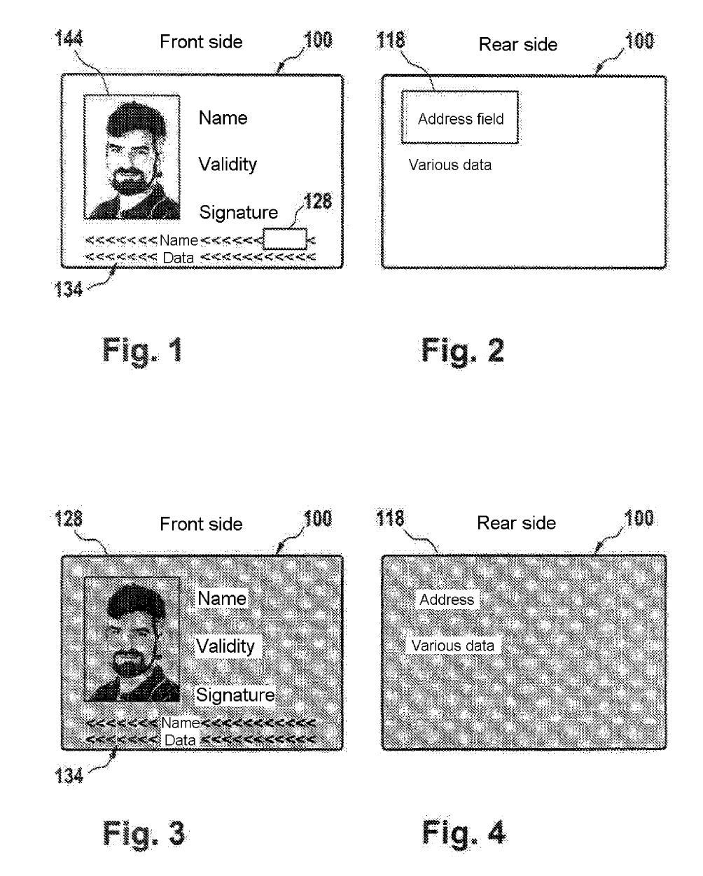

FIG. 1 shows a diagrammatic illustration of a front side of one embodiment of a document according to the invention,

FIG. 2 shows a diagrammatic illustration of the rear side of the embodiment in FIG. 1,

FIG. 3 shows a diagrammatic illustration of the front side of one embodiment of a document according to the invention,

FIG. 4 shows a diagrammatic illustration of the rear side of the embodiment in FIG. 3,

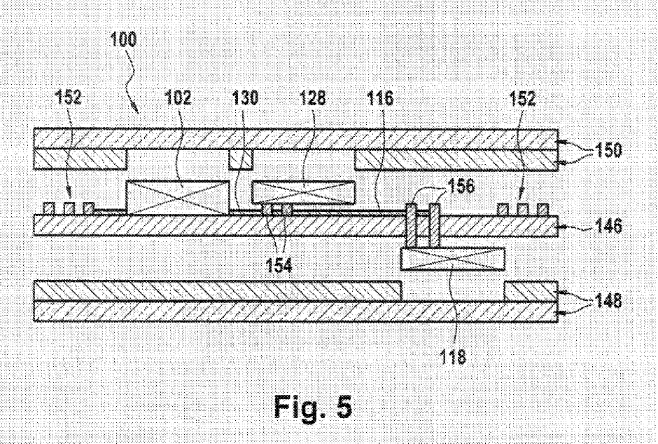

FIG. 5 shows a diagrammatic sectional illustration of one embodiment of a document according to the invention,

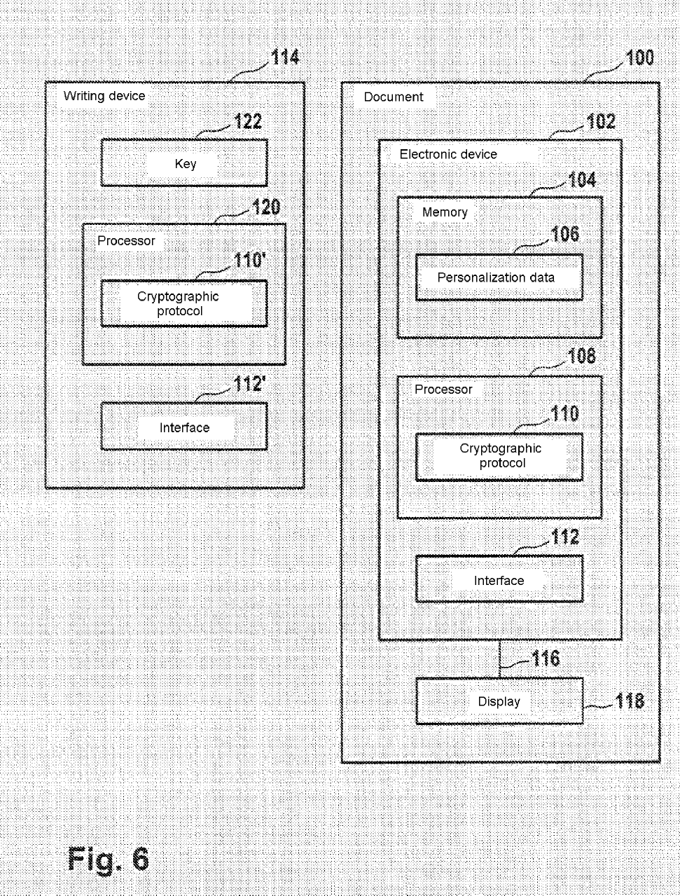

FIG. 6 shows a block diagram of another embodiment of a document according to the invention and a writing device according to the invention,

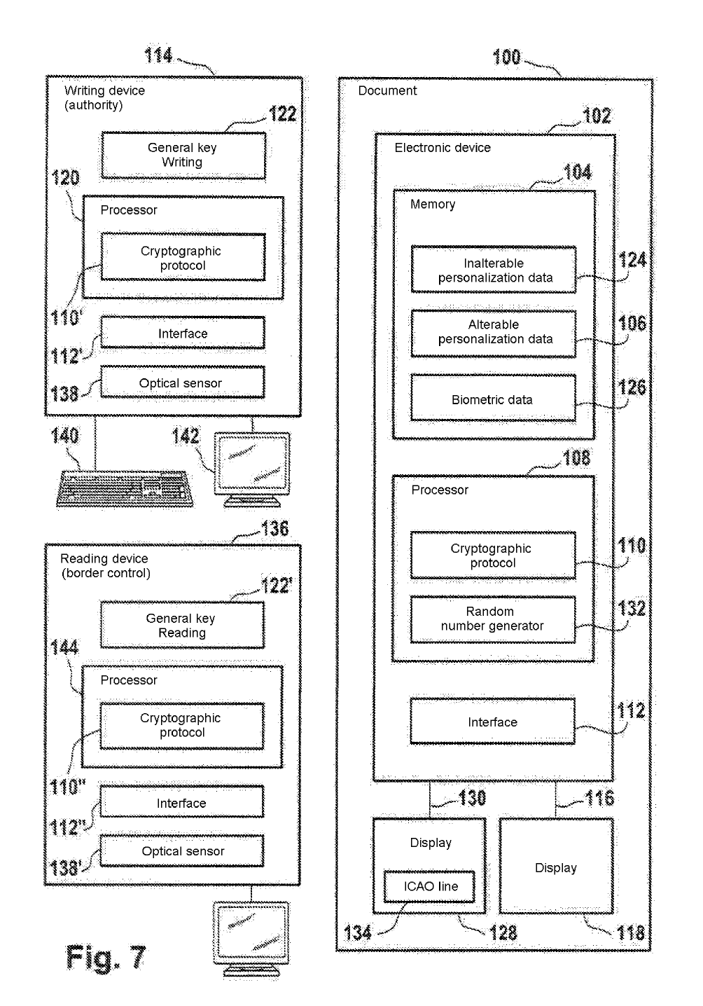

FIG. 7 shows a block diagram of another embodiment of a document according to the invention and a writing device according to the invention as well as a reading device.

Elements in the following embodiments which correspond to one another are denoted using the same reference symbols.

FIG. 1 shows the front side of a document 100. The document 100 is an identification document in the embodiment under consideration here. The document 100 is paper-based and/or plastic-based. A facial image 144 of the bearer of the document 100 as well as further personalization data, for example the name of the bearer of the document 100, the validity of the document 100 as well as a reproduction of a sample signature of the bearer of the document 100, are printed on the document 100. The document 100 has the so-called MRZ (machine readable zone) line 134 on its lower edge. The display device 128 is arranged inside the ICAO line in such a manner that an identifier generated by the document can be optically read as part of the ICAO line on the front side of the document 100.

FIG. 2 shows the rear side of the document 100 in FIG. 1. A display device 118 is visible on the rear side of the document 100. The display device 118 has, for example, an address field for displaying the address of the bearer of the document 100. Furthermore, further inalterable personalization data, for example the signature, can be printed on the rear side of the document 100.

FIG. 3 shows the front side of a further embodiment of the document 100. In this embodiment, a display device 128 is formed over the entire area, with the result that it essentially covers the entire front side of the document 100. Personal data, preferably all personal data, for example the facial image 144, the name, the validity, the signature and the entire MRZ 134, are accordingly output using the display device 128.

A corresponding situation applies to the rear side of the document 100 (cf. FIG. 4), which is formed by the display device 118. In addition to displaying the alterable personalization data, that is to say the address, the display device 118 is also used to display further data, for example also the inalterable personalization data. In addition, static labels may also be displayed by the display device 118, for example the labeling of the data fields with the corresponding field designations, for example the field designation “name/surname/nom” for the surname field. If these field designations are not displayed by the display device 118, they may also be applied using printing technology, for example.

FIG. 5 shows a diagrammatic cross section of one embodiment of the document 100 according to the invention. This embodiment of the document 100 is a so-called smart card. The document is constructed from a plurality of layers 146, 148 and 150.

The layer 146 is composed of a film, the so-called inlay, on which an electronic device 102 is situated. The electronic device 102 may be in the form of, for example, an integrated electronic circuit, for example a microcontroller. Furthermore, an antenna 152 for contactless communication with an external terminal, for example a writing device or reading device, is situated on the inlay of the layer 146. Alternatively or additionally, the electronic device 102 may also have an interface with contacts or a dual interface.

The display devices 128 and 118 are applied to the inlay of the layer 146. In order to contact-connect said devices to the electronic device 102, the conductor tracks 116 and 130 are applied to the inlay and contact-connect the display devices 128 and 118 using so-called vias 154 and 156, respectively.

The two display devices 118 and 128 may, but need not, use the same display technology. In one embodiment of the invention, the display device 128 does not have a storage action or has only a small storage action and relatively short persistence for the displayed image, whereas the display device 118 for the address field is a bistable display. Alternatively or additionally, suitable drive logic can be used to ensure that the display device 128 does not have a storage action.

If an identifier which is determined by the electronic device 102 is displayed on the display device 128, this can improve the security of the encryption for the interchange of data between the electronic device 102 and the reading or writing device on account of the associated additional variable parameter in the data in the MRZ 134 which are optically read. In the event of the display device 128 not displaying an image in the normal state, the reading device can first of all check whether no information is in fact displayed on the display device 128. A protocol may be run through for a bistable display device, in which case, for example, a predetermined content—even without any display function—is first of all displayed and only then is the actual information displayed, with the result that the reading device can check the functionality of the display device. At the end of the protocol, the display device can be overwritten with a further item of information, or no more information is then displayed. This makes it possible to ensure that the information then cannot be read by unauthorized persons. This also ensures that the document can be manipulated, for example, by means of a sticker on the display device since said sticker would indeed indicate only static information.

The display device 118 for the address field is intended to display the address in a stable manner for years even if the document is not in a reading device, that is to say is not supplied with power. Bistable display technologies are therefore particularly suitable for implementing the display device 118.

The display device 128 may likewise be in the form of a bistable display. In order to prevent manipulation, the reading device may first of all request a particular item of information, for example the time, to be displayed by the electronic device 102 here. This makes it possible for the reading device to check the functionality of the display device 128. The reading device than requests the electronic device 102 to generate the identifier and display it on the display device 128.

FIG. 6 shows another embodiment of a document 100 according to the invention. The document 100 may be, for example, a paper-based document or a chip card. The document 100 has an electronic device 102 having a data memory 104 for storing personalization data 106.

The electronic device 102 has a processor 108 for executing program instructions 110 which are used to carry out those steps of a cryptographic protocol which relate to the document 100.

The electronic device 102 also has an interface 112 for communicating with a corresponding interface 112′ of a writing device 114. The interfaces 112, 112′ may have contacts, may be wireless or may be in the form of dual interfaces. In particular, an RFID system may be formed by the writing device 114 and the document 100. The writing device 114 can supply the electronic device 102, in particular the processor 108, with electrical power via the interface 112′.

The electronic device 102 is connected to a display device 118 using a conductor track 116. The display device 118 is used to display the personalization data 106 or parts of the personalization data 106 on the document 100. The display device 118 may be a double-sided display element, on the front and rear sides of which information can be reproduced. In this case, two display devices are implemented using a single double-sided display element. Alternatively or additionally, at least one further display device may be provided in addition to the display device 118, as illustrated in the further embodiments in FIGS. 2 to 7.

The electronic device 102 or parts of the latter may be in the form of an integrated electronic circuit, for example a microcontroller.

Designing the document 100 with a double-sided display element or at least two display devices provides particular protection against forgery on account of the resultant structure of the document 100, in particular if the document 100 is flat and has, for example, a thickness of at most 2 mm. Externally supplying the document 100 with power also makes it possible to dispense with a power source integrated in the document, which is advantageous for the functionality of the document 100 over a relatively long period of time.

The interfaces 112′ and 112 are preferably contactless or in the form of dual interfaces, which is likewise advantageous for the long-term functionality of the document 100; in particular, the problem of corrosion of contacts of the interfaces 112′ and 112 is then eliminated.

The writing device 114 has a processor 120 for executing program instructions 110′ which are used to carry out those steps of the cryptographic protocol which relate to the writing device 114. The writing device 114 needs a key 122 in order to carry out the cryptographic protocol.

The following procedure is used to update the personalization data 106 or variable parts of the personalization data:

The execution of the program instructions 110 and 110′ is started in order to carry out the cryptographic protocol. For example, the execution of the program instructions 110′ on the writing device 114 is first of all started, whereupon a control signal is transmitted from the writing device 114 to the electronic device 102 via the interfaces 112′ and 112, whereupon the execution of the program instructions 110 is started in said electronic device.

The cryptographic protocol is then carried out using the key 122. After the cryptographic protocol has been successfully carried out, the processor 108 enables write access to the data memory 104, with the result that the writing device 114 can transmit updated personalization data to the electronic device 102 via the interface 112′ and the interface 112, which updated personalization data are then stored in the data memory 104 of said electronic device. This may be carried out in such a manner that the personalization data 106 are overwritten with the updated personalization data.

The updated personalization data then appear on the display device 118, the document 100 otherwise being able to remain unaltered. It is particularly advantageous in this case that the document 100 need not be replaced with a new one in order to update the personalization data 106 and that, on the other hand, the personalization data 106 are updated in a manner which does not diminish the trustworthiness of the document 100 on account of the protection afforded by the cryptographic protocol.

FIG. 7 shows another embodiment of a document 100 according to the invention. In this embodiment, in addition to storing the alterable personalization data 106, the data memory 104 is used to store inalterable personalization data 124 and to store biometric data 126. If the document is an identification document, the name and current address of the bearer of the document may be stored, for example, as the alterable personalization data 106 and the height, date of birth and gender may be stored as the inalterable personalization data 124 in the data memory 104. The biometric data 126 may be a facial image, facial features, fingerprint data, an iris scan or similar biometric data relating to the bearer of the document 100.

Bistable display technology or another display technology may likewise be selected for the display device 128. For example, the display device 128 may be in the form of an LCD or OLED display device. In the latter case, electrical power is needed to operate the display device 128 in order to display the content.

In the exemplary embodiment under consideration here, the writing device 114 is assigned to an authority that is authorized to update the alterable personalization data 106. For this purpose, the key 122 is in the form of a “general key” for write access operations. The key 122 may be stored in the writing device 114 itself, on a chip card which can be inserted into the writing device 114 or on an external server computer with which the writing device 114 can communicate.

The writing device 114 has a keyboard 140 and a display device 142, for example a screen.

The following procedure is used to update the alterable personalization data 106:

The document 100 is brought into the vicinity of the writing device 114, with the result that data can be interchanged between the writing device 114 and the document 100 via the interfaces 112′ and 112. For this purpose, the document 100 is inserted into the writing device 114 or placed on the latter, for example.

An authorized user of the writing device 114 uses the keyboard 140 to input updated personalization data which are displayed on the display device 142. The execution of the program instructions 110′ is started by operating the input key on the keyboard 140.

The processor 120 then generates a control signal which is transmitted to the electronic device 102 via the interfaces 112′, 112. Depending on the form of implementation of the document 100, it may then be necessary for the control signal to be sent to the document as an activation signal in order to announce the imminent access to the data memory. The execution of the program instructions 132 is then started, with the result that an identifier, for example a random number, is generated.

The identifier is output in the region of the MRZ 134 using the display device 128. The identifier which is output in the region of the ICAO line 135 is detected by the writing device 114 using its optical sensor 132. The processor 120 then causes a further key to be obtained from the identifier and the key 122 by executing the program instructions 110′, which further key is used to carry out the cryptographic protocol. For example, a symmetrical or an asymmetrical key which is needed to successfully carry out the cryptographic protocol for the planned write access is generated in this manner.

In one embodiment of the invention, an asymmetrical pair of keys comprising a secret key and a public key is generated, for example, from the identifier and the key 122. The public key is then transmitted from the writing device 114 to the electronic device 102 via the interfaces 112′, 112. A further random number which is encrypted with the aid of the public key is then generated by executing the program instructions 132.

The ciphertext resulting from the encryption is transmitted from the electronic device 102 to the writing device 114 via the interfaces 112, 112′. The writing device 114 decrypts the ciphertext with the aid of the private key. The decryption result is transmitted from the writing device 114 to the electronic device 102 via the interfaces 112′, 112.

A comparison is then carried out, by executing the program instructions 110, in order to determine whether the decryption result corresponds to the originally generated random number. If this is the case, authorization of the writing device 114 to carry out the write access is thus proven and the write access is then enabled. As a result of the write access, the updated personalization data which were previously input using the keyboard 140 are then transmitted to the document 100 and are stored in the data memory 104.

In the embodiment under consideration here, the reading device 136 is assigned to border control. The reading device 136 is, in principle, constructed in a similar manner to the writing device 114. The reading device 136 has a processor 144 for executing program instructions 110″. The program instructions 110″ are used to carry out those steps of a cryptographic protocol which relate to the reading device 136. This cryptographic protocol may be identical to or different from the steps implemented by the program instructions 110′ of the writing device 114.

In order to carry out the cryptographic protocol, the reading device 136 uses a key 122′ which authorizes the reading device 136 to have read access to the biometric data 126. The key 122′ may be stored in the reading device 136 or in an external cryptographic component, for example a chip card or a server computer which can be addressed via a network. In the two latter cases, a cryptographic algorithm for carrying out the cryptographic protocol is preferably carried out in the chip card or in the server computer.

The method of operation of the reading device 136 corresponds to that of the writing device 114, the key 122′ which only enables the biometric data 126 to be read being used to carry out the cryptographic protocol. After the cryptographic protocol has been successfully carried out, the reading device 126 can correspondingly receive the biometric data 126 via the interfaces 112, 112″.

### LIST OF REFERENCE SYMBOLS

100 Document
102 Electronic device
104 Data memory
106 Personalization data
108 Processor
110 Program instructions
110′ Program instructions
110″ Program instructions
112 Interface
112′ Interface
112″ Interface
114 Writing device
116 Conductor track
118 Display device
120 Processor
122 Key
122′ Key
124 Personalization data
126 Biometric data
128 Display device
130 Conductor track
132 Program instructions
134 MRZ
136 Reading device
138 Optical sensor
138′ Optical sensor
140 Keyboard
142 Display device
144 Facial image
146 Layer
148 Layer
150 Layer
152 Antenna
154 Via
156 Via

1.-28. (canceled)

29. A security or valuable document, comprising:
at least first and second display devices,
a processor for driving the at least first and second display devices, and
an interface for supplying power to the processor from an external power source,
wherein at least one of the display devices is designed in such a manner that it also displays information when the interface is disconnected from the external power source.

30. The security or valuable document as claimed in claim 29, wherein the first and second display devices are arranged on opposite sides of the security or valuable document.

31. The security or valuable document as claimed in claim 29, further comprising a data memory for storing personalization data, and means for carrying out a cryptographic protocol, the interface being designed for external write access to the data memory in order to alter the personalization data, and the external write access presupposing that the cryptographic protocol has been carried out.

32. The security or valuable document as claimed in claim 31, further comprising means for generating an identifier for use for the cryptographic protocol.

33. The security or valuable document as claimed in claim 32, wherein a second key is for carrying out the cryptographic protocol being able to be generated from the identifier and a first key.

34. The security or valuable document as claimed in claim 32, wherein the means for generating the identifier is designed in such a manner that the identifier changes after intervals of time.

35. The security or valuable document as claimed in claim 32, wherein the means for generating the identifier is designed in such a manner that an identifier is generated for each external write and/or read access.

36. The security or valuable document as claimed in claim 32, wherein the identifier comprises a random number and/or a time.

37. The security or valuable document as claimed in claim 31, wherein the data memory is used to store inalterable personalization data, and the first and/or second display device is designed to display the inalterable personalization data.

38. The security or valuable document as claimed in claim 29, wherein the first and/or second display device is an electrophoretic display, an electrochromic display, an electrowetting display, a bistable display, a rotating element display, an LCD display or an OLED display.

39. The security or valuable document as claimed in claim 31, further comprising an inlay and conductor tracks which are arranged in or on the inlay and are intended to contact-connect the first and/or second display device to the processor.

40. The security or valuable document as claimed in claim 39, wherein the processor, the data memory, the means for carrying out the cryptographic protocol and/or the interface is integrated in a circuit, and the circuit is arranged in or on the inlay.

41. The security or valuable document as claimed in claim 39, wherein the first and/or second display device is contact-connected using plated-through holes.

42. The security or valuable document as claimed in claim 29, wherein said document is an identification document, a passport, an ID card, a visa, a driving license, a company ID card, an authorization permit or the like.

43. The security or valuable document as claimed in claim 29, wherein the first and second display devices are implemented using a single display element, and the display element is designed to display different information on both sides.
